(19) United States
(12) Patent Application Publication
(10) Pub. No.: US 2026/0291635 A1
(43) Pub. Date: Sep. 24, 2026

(54) NETWORK TEST APPARATUS AND TIME SOURCE SELECTION METHOD THEREOF

(71) Applicant: ANRITSU CORPORATION, Kanagawa (JP)

(72) Inventor: Saaya CHIBA, Kanagawa (JP)

(21) Appl. No.: 19/459,327

(22) Filed: Jan. 26, 2026

(30) Foreign Application Priority Data
Mar. 18, 2025 (JP) 2025-043871

(51) Int. Cl. H04J 3/06; H04L 43/50

(52) U.S. Cl. CPC H04J 3/0641; H04L 43/50

(57) ABSTRACT

There is provided a network test apparatus capable of obtaining a measurement result having a high quality. The network test apparatus includes a transmission and reception unit that is connected to a network under test or a device under test and transmits and receives a packet to and from the network under test or the device under test in accordance with a predetermined communication standard, a reference oscillator that generates an oscillation signal having a predetermined frequency, and a control unit that selects an NTP server which is connected to the network connected via the transmission and reception unit and satisfies a predetermined NTP server condition, and sets the NTP server as a time source.

### TECHNICAL FIELD

The present invention relates to a network test apparatus that measures a network performance of a network under test or a device under test (DUT).

### BACKGROUND ART

For example, a network test apparatus tests whether or not network performance, such as a throughput, a delay, or a synchronization error (time error) of a wireless terminal (user equipment (UE)) as a network under test or a device under test, which performs mobile communication using a mobile communication system, which is a difference from a reference time, such as a coordinated universal time (UTC), is a desired performance.

In such a network test apparatus, in order to obtain a measurement result having a high quality in measuring the delay or the like, a time source having high accuracy is required.

Patent Document 1 discloses that, in a case where a setting voltage of a reference oscillator is controlled based on a global navigation satellite system (GNSS) signal received from a GNSS satellite and a slope of a change in the setting voltage of the reference oscillator (the amount of change in the setting voltage per unit time) falls within a permissible range, a determination is made that a transition to holdover is to be made at an appropriate time.

### RELATED ART DOCUMENT

### [Patent Document]

[Patent Document 1] Japanese Patent No. 7432639

### Disclosure of the Invention

### Problem that the Invention is to Solve

Meanwhile, in an environment in which the network test apparatus is used, there is a problem that it is uncertain whether or not the measurement result has high quality depending on a reception situation of the GNSS signal, such as the number of satellites used or a state of a propagation path.

Therefore, an object of the present invention is to provide a network test apparatus capable of selecting a time source having high accuracy and obtaining a measurement result having a high quality.

### Means for solving the problem

According to the present invention, there is provided a network test apparatus (1) including: a reference oscillator (6) that generates an oscillation signal having a predetermined frequency; a control unit (9) that controls the frequency of the oscillation signal generated by the reference oscillator; and a network connection unit (5) that is connected to a network and communicates with a device connected to the network, in which the control unit selects, via the network connection unit, a network time protocol (NTP) server that is connected to the network and satisfies a predetermined NTP server condition, and sets the NTP server as a time source.

With this configuration, the NTP server satisfying the NTP server condition is selected as the time source. Therefore, the time source having high accuracy is selected, and a measurement result having a high quality can be obtained.

In addition, the network test apparatus according to the present invention, further includes: a global navigation satellite system (GNSS) receiver (4) that receives a GNSS signal from a GNSS satellite, in which in a case where there is no NTP server satisfying the NTP server condition, the control unit selects a GNSS signal satisfying a predetermined GNSS signal condition from the GNSS signal received by the GNSS receiver, and sets the GNSS signal as the time source.

With this configuration, in a case where there is no NTP server that satisfies the NTP server condition, the GNSS signal that satisfies the predetermined GNSS signal condition is selected as the time source. Therefore, the time source having high accuracy is selected, and a measurement result having a high quality can be obtained.

In addition, in the network test apparatus according to the present invention, in a case where there is no NTP server satisfying the NTP server condition and there is no GNSS signal satisfying the GNSS signal condition, the control unit searches for an NTP server satisfying a delay time or a fluctuation, which is the NTP server condition, or a GNSS signal satisfying a signal strength or a signal quality, which is the GNSS signal condition, in accordance with a preset priority.

With this configuration, in a case where there is no NTP server that satisfies the NTP server condition and there is no GNSS signal that satisfies the GNSS signal condition, the NTP server that satisfies the NTP server condition or the GNSS signal that satisfies the GNSS signal condition is searched in accordance with the preset priority.

Therefore, the time source having high accuracy is selected, and a measurement result having a high quality can be obtained.

In addition, in the network test apparatus according to the present invention, the control unit switches the time source according to a predetermined measurement condition, a predetermined cycle, or an operation by a user.

With this configuration, the time source is switched according to the predetermined measurement condition, the predetermined cycle, or the operation by the user. Therefore, by switching the time source in accordance with a change in the measurement condition, the peripheral environment or the request of the user, a time source with high accuracy is selected, and a measurement result with high quality can be obtained.

In addition, in the network test apparatus according to the present invention, the control unit changes the NTP server condition or the GNSS signal condition in accordance with a measurement item or a measurement scene in network measurement.

With this configuration, the NTP server condition or the GNSS signal condition is changed in accordance with the measurement item or the measurement scene in the network measurement. Therefore, an appropriate time source is selected according to the measurement item or the measurement scene, and a measurement result having a high quality can be obtained.

In addition, in the network test apparatus according to the present invention, the control unit sets the NTP server condition or the GNSS signal condition according to a selected time accuracy or measurement accuracy.

With this configuration, the NTP server condition or the GNSS signal condition is set according to the time accuracy or the measurement accuracy. Therefore, an appropriate time source is selected according to the time accuracy or the measurement accuracy, and a measurement result having a high quality can be obtained.

In addition, in the network test apparatus according to the present invention, the control unit stores a plurality of candidates of the NTP server set as the time source, and enables a user to add and delete the candidate.

With this configuration, the user can add and delete candidates of the NTP server set as the time source. Therefore, the user can select a candidate of the NTP server set as the time source, and a measurement result having a high quality can be obtained.

In addition, in the network test apparatus according to the present invention, the control unit deletes an NTP server that satisfies a predetermined condition, from the candidates of the NTP server set as the time source.

With this configuration, the NTP server satisfying the predetermined condition is deleted from the candidates of the NTP server set as the time source. Therefore, an NTP server or the like having low accuracy is automatically deleted, and a measurement result having a high quality can be obtained.

In addition, in the network test apparatus according to the present invention, the control unit records information on the selected time source, together with a measurement result.

With this configuration, the information on the time source selected at that time is recorded, together with the measurement result. Therefore, the measurement result and the information on the time source can be associated with each other, and the quality of the measurement result can be determined from the information on the time source.

In addition, according to the present invention, there is provided a time source selection method of a network test apparatus (1) including a reference oscillator (6) that generates an oscillation signal having a predetermined frequency, a network connection unit (5) that is connected to a network and communicates with a device connected to the network, and a control unit (9) that controls the frequency of the oscillation signal generated by the reference oscillator, the method including: a step of selecting an NTP server that is connected to the network via the network connection unit and satisfies a predetermined NTP server condition, and setting the NTP server as a time source.

With this configuration, the NTP server satisfying the NTP server condition is selected as the time source. Therefore, the time source having high accuracy is selected, and a measurement result having a high quality can be obtained.

### Advantage of the Invention

The present invention can provide a network test apparatus capable of obtaining a measurement result having a high quality.

### BRIEF DESCRIPTION OF THE DRAWINGS

FIG. 1 is a block diagram of a network test apparatus according to an embodiment of the present invention.

FIG. 2 is a flowchart illustrating a procedure of a time source selection process of the network test apparatus according to the embodiment of the present invention.

### BEST MODE FOR CARRYING OUT THE INVENTION

Hereinafter, a network test apparatus according to an embodiment of the present invention will be described in detail with reference to the drawings.

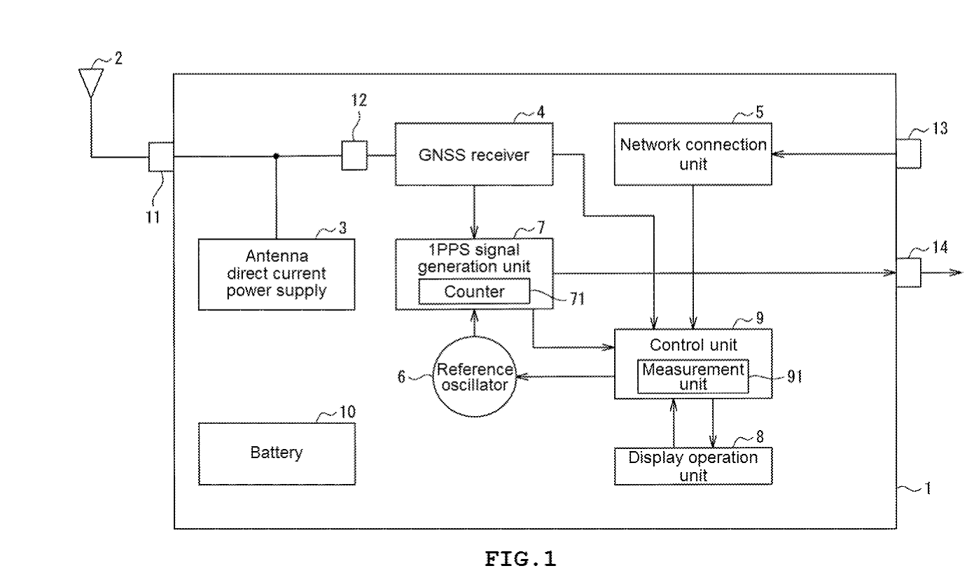

In FIG. 1, a network test apparatus 1 according to an embodiment of the present invention includes a GNSS antenna 2, an antenna direct current power supply 3, a GNSS receiver 4, a transmission and reception unit 5 as a network connection unit, a reference oscillator 6, a 1PPS signal generation unit 7, a display operation unit 8, a control unit 9, and a battery 10.

The GNSS antenna 2 receives a GNSS signal transmitted from a GNSS satellite (not illustrated). The GNSS antenna 2 is attachably and detachably connected to a connector 11 provided in an apparatus main body of the network test apparatus 1.

The antenna direct current power supply 3 supplies a power supply voltage required for the GNSS antenna 2 connected to the connector 11.

The GNSS receiver 4 receives the GNSS signal transmitted from the GNSS antenna 2 via the connector 11 and a capacitor 12. The GNSS receiver 4 outputs, for example, a reference 1 pulse per second (1PPS) signal to the 1PPS signal generation unit 7 and the control unit 9, based on the GNSS signal received from the GNSS antenna 2. The GNSS receiver 4 measures a signal strength, a signal quality, or the like of the GNSS signal received from the GNSS antenna 2, and transmits the measured value to the control unit 9 as GNSS signal information.

The GNSS receiver 4 can receive, for example, a signal of a global positioning system (GPS), a signal of a global navigation satellite system (GLONASS), a signal of Galileo, a signal of a BeiDou navigation system (BDS), or the like as the GNSS signal.

The transmission and reception unit 5 is connected to a network under test or a device under test (not illustrated) via a measurement terminal 13, and transmits and receives a packet to and from the network under test or the device under test, in accordance with a predetermined communication standard. The transmission and reception unit 5 transmits the received packet to the control unit 9. The transmission and reception unit 5 transmits a packet created by the control unit 9 according to a predetermined communication standard. The predetermined communication standard is, for example, Ethernet (registered trademark) or the like.

The reference oscillator 6 is a frequency oscillator which is built in the apparatus main body and of which a frequency is controlled by a voltage set from the control unit 9. The reference oscillator 6 outputs, for example, an oscillation signal having a high stability such as a reference frequency of 10 MHz to the 1PPS signal generation unit 7. The reference oscillator 6 functions as a time source that supplies a time to the network test apparatus 1.

The 1PPS signal generation unit 7 includes a counter 71 that counts a reference 1PPS signal generated based on a GNSS signal received by the GNSS receiver 4 from the GNSS satellite, and outputs a count value of the counter 71 to the control unit 9. The 1PPS signal generation unit 7 generates a 1PPS signal based on an oscillation signal of the reference oscillator 6, and outputs the 1PPS signal from a connector 14.

That is, while the GNSS signal is received from the GNSS receiver 4, the control unit 9 controls the set voltage of the reference oscillator 6 based on the count value by the counter 71, the oscillation signal synchronized with the GNSS signal is output from the reference oscillator 6, and the GNSS signal becomes a time source.

The display operation unit 8 is configured with, for example, a touch panel that is used for both a display function and an input operation function, and displays an image for inputting measurement conditions necessary for performing various measurements, various parameters, and the like, an image indicating a result in a case where various measurements are performed, or the like, and outputs information and the like input by an operation on these images to the control unit 9.

The control unit 9 is configured with a computer unit or the like including, for example, a central processing unit (CPU), a random access memory (RAM), a read only memory (ROM), a hard disk device, and an input and output port (not illustrated).

The ROM and the hard disk device of this computer unit store various control constants, various maps, and the like, as well as a program for causing the computer unit to function as the control unit 9. That is, the computer unit functions as the control unit 9 by the CPU executing the program stored in the ROM and the hard disk device. The hard disk device may be a compact flash (CF) card or the like using a flash memory.

The GNSS receiver 4, the transmission and reception unit 5, the 1PPS signal generation unit 7, and the display operation unit 8 are connected to the input and output port of the control unit 9, and the control unit 9 and each unit can transmit and receive signals.

The control unit 9 includes a measurement unit 91 that transmits and receives packets with the network under test or the device under test to measure a delay, a throughput, and the like of the network under test and the device under test.

The battery 10 is provided to be attachable to and detachable from the apparatus main body of the network test apparatus 1, and supplies a power source necessary for driving each unit in a case where various measurements are performed. The battery 10 is not essential since the battery 10 can be used in an environment in which the network test apparatus 1 is used, and a commercial power source or the like may be used.

In the present embodiment, in order to obtain a measurement result having a high quality in measuring the delay by the measurement unit 91, a time source having high accuracy of a time is required as a time source for supplying the time to the network test apparatus 1.

Therefore, the control unit 9 performs time synchronization using a network time protocol (NTP) server connected to a network connected via the transmission and reception unit 5 as the time source, and inputs the synchronized time to the measurement unit 91. A configuration may be provided in which the set voltage of the reference oscillator 6 is controlled based on the time synchronized with the NTP server to output the oscillation signal synchronized with the NTP server from the reference oscillator 6, or to generate a 1PPS signal.

The control unit 9 stores a plurality of candidates of the NTP server that performs time synchronization as the time source, and selects the NTP server that satisfies all predetermined NTP server conditions, for example, such as a delay time and a fluctuation, to perform time synchronization.

As a known technology, Root Delay representing a delay to an NTP server included in an NTP packet, Root Dispersion representing a fluctuation in a delay to an NTP server, or the like may be used for a calculation of a delay time and a fluctuation. In addition, the NTP server may add a priority or a weighting of the upper and lower layers from stratum 0 to stratum N (N is a positive integer) as a level of a hierarchy in NTP, in addition to the delay time and the fluctuation.

A user can add or delete a candidate of the NTP server to be synchronized in time. In addition, in a case where the predetermined number of accesses to the candidate of the NTP server is not available or the predetermined number of NTP server conditions is not satisfied, the candidate for time synchronization of the NTP server may be automatically deleted from the candidate of the NTP server and a notification may be made of the deletion or a deletion proposal may be made. The priority may be given to the candidates of the NTP server, for example, a determination of whether or not the NTP server condition is satisfied may be made in accordance with the priority such as the delay time and the fluctuation, and in a case where there is an NTP server satisfying the NTP server condition, the time may be synchronized with the NTP server, and the determination of the NTP server condition of the NTP server having the priority thereafter may not be made.

In a case where there is no NTP server satisfying the NTP server condition, the control unit 9 performs time synchronization using, for example, a GNSS signal satisfying all the conditions, such as a signal strength and a signal quality, which is selected based on a predetermined GNSS signal condition and the GNSS signal information from the GNSS receiver 4 as a time source. The priority may be given to the receivable GNSS signal, and it may be determined whether or not the GNSS signal condition is satisfied in accordance with the priority, and in a case where there is a GNSS signal satisfying the GNSS signal condition such as the signal strength or the signal quality, for example, the GNSS signal condition of the GNSS signal may be determined in synchronization in time with the GNSS signal, and the GNSS signal condition of the GNSS signal having the priority thereafter may not be determined.

In a case where there is no NTP server satisfying the NTP server condition and the GNSS signal satisfying the GNSS signal condition cannot be received, the control unit 9 sets the reference oscillator 6 as the time source.

In a case where there is no NTP server satisfying the NTP server condition and the GNSS signal satisfying the GNSS signal condition cannot be received, the control unit 9 tries to search for the NTP server satisfying the NTP server condition or the GNSS signal satisfying the GNSS signal condition in accordance with the priority using the time of the reference oscillator 6 as the time source. In the search for the NTP server satisfying the NTP server condition or the GNSS signal satisfying the GNSS signal condition, in a case where the NTP server satisfying the NTP server condition or the GNSS signal satisfying the GNSS signal condition is present, the control unit 9 may use the NTP server or the GNSS signal as the time source.

The control unit 9 performs switching between a new time source selected by searching for an NTP server satisfying the NTP server condition and a new time source selected by searching for a GNSS signal satisfying the GNSS signal condition, according to a predetermined measurement condition, a predetermined cycle, or an operation by a user.

The control unit 9 changes the NTP server condition or the GNSS signal condition in accordance with a measurement item or a measurement scene in the network measurement.

The measurement item is, for example, a measurement of a throughput, a delay, and a jitter in a network, and the measurement scene is a measurement including a mobile network, a measurement in a local network, and the like.

The control unit 9 may set the NTP server condition or the GNSS signal condition according to the selected time accuracy or measurement accuracy. For example, the control unit 9 stores an NTP server condition or a GNSS signal condition corresponding to the time accuracy or the measurement accuracy, and sets the corresponding NTP server condition or GNSS signal condition by selecting the time accuracy or the measurement accuracy of the user.

The control unit 9 records, for example, information on which of the NTP server, the GNSS signal, or the reference oscillator 6 is selected as the time source, information on the time source selected, or the like, together with the measurement result in a storage unit (not illustrated). Examples of the information on the time source include a delay time, a fluctuation, and the like in a case of an NTP server, and a signal strength, a signal quality, and the like in a case of a GNSS signal.

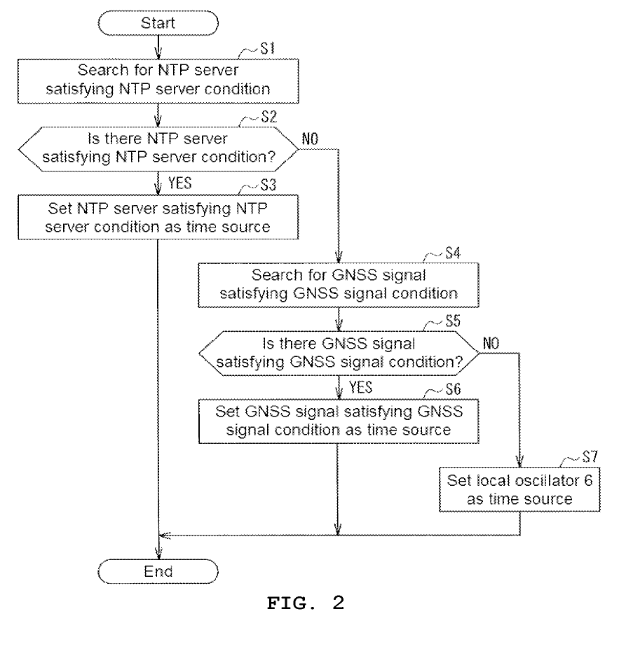

A time source selection process by the network test apparatus 1 according to the present embodiment configured as described above will be described with reference to FIG. 2. The time source selection process, which will be described below, is executed according to a predetermined measurement condition, a predetermined cycle, or an operation by a user.

In step S1, the control unit 9 searches for an NTP server that satisfies an NTP server condition. After executing the process in step S1, the control unit 9 executes a process in step S2.

In step S2, the control unit 9 determines whether or not there is an NTP server that satisfies the NTP server condition.

In a case where it is determined that there is the NTP server satisfying the NTP server condition, the control unit 9 executes a process in step S3. In a case where it is determined that there is no NTP server satisfying the NTP server condition, the control unit 9 executes a process in step S4.

In step S3, the control unit 9 sets the NTP server satisfying the NTP server condition as a time source. After executing the process in step S3, the control unit 9 ends the time source selection process.

In step S4, the control unit 9 searches for a GNSS signal satisfying a GNSS signal condition. After executing the process in step S4, the control unit 9 executes a process in step S5.

In step S5, the control unit 9 determines whether or not there is a GNSS signal satisfying the GNSS signal condition.

In a case where it is determined that there is the GNSS signal satisfying the GNSS signal condition, the control unit 9 executes a process in step S6. In a case where it is determined that there is no GNSS signal satisfying the GNSS signal condition, the control unit 9 executes a process in step S7.

In step S6, the control unit 9 sets the GNSS signal satisfying the GNSS signal condition as the time source. After executing the process in step S6, the control unit 9 ends the time source selection process.

In step S7, the control unit 9 sets the reference oscillator 6, which is a local transmitter, as the time source. After executing the process in step S7, the control unit 9 ends the time source selection process.

In this manner, in the embodiment described above, the control unit 9 selects an NTP server satisfying the predetermined NTP server condition, and uses the selected NTP server as the time source.

Accordingly, the NTP server that satisfies the NTP server condition is selected as the time source. Therefore, the time source having high accuracy is selected, and a measurement result having a high quality can be obtained.

In addition, in a case where there is no NTP server satisfying the NTP server condition, the control unit 9 selects a GNSS signal satisfying a predetermined GNSS signal condition from the GNSS signal received by the GNSS receiver 4, and sets the selected GNSS signal as the time source.

Accordingly, in a case where there is no NTP server that satisfies the NTP server condition, the GNSS signal that satisfies the predetermined GNSS signal condition is selected as the time source. Therefore, the time source having high accuracy is selected, and a measurement result having a high quality can be obtained.

In addition, in a case where there is no NTP server satisfying the NTP server condition and there is no GNSS signal satisfying the GNSS signal condition, the control unit 9 searches for an NTP server satisfying a delay time or a fluctuation, which is the NTP server condition, or a GNSS signal satisfying a signal strength or a signal quality, which is the GNSS signal condition, in accordance with a preset priority.

Accordingly, in a case where there is no NTP server that satisfies the NTP server condition and there is no GNSS signal that satisfies the GNSS signal condition, the NTP server that satisfies the NTP server condition or the GNSS signal that satisfies the GNSS signal condition is searched in accordance with the preset priority. Therefore, the time source having high accuracy is selected, and a measurement result having a high quality can be obtained.

In addition, the control unit 9 switches the time source according to a predetermined measurement condition, a predetermined cycle, or an operation by a user.

Accordingly, the time source is switched according to the predetermined measurement condition, the predetermined cycle, or the operation by the user. Therefore, by switching the time source in accordance with a change in the measurement condition, the peripheral environment or the request of the user, a time source with high accuracy is selected, and a measurement result with high quality can be obtained.

In addition, the control unit 9 changes the NTP server condition or the GNSS signal condition in accordance with the measurement item or the measurement scene in the network measurement.

Accordingly, the NTP server condition or the GNSS signal condition is changed in accordance with the measurement item or the measurement scene in the network measurement. Therefore, an appropriate time source is selected according to the measurement item or the measurement scene, and a measurement result having a high quality can be obtained.

In addition, the control unit 9 sets the NTP server condition or the GNSS signal condition according to the selected time accuracy or measurement accuracy.

Accordingly, the NTP server condition or the GNSS signal condition is set according to the time accuracy or the measurement accuracy. Therefore, an appropriate time source is selected according to the time accuracy or the measurement accuracy, and a measurement result having a high quality can be obtained.

In addition, the control unit 9 stores a plurality of candidates of the NTP server set as the time source, and enables the user to add and delete the candidate.

Accordingly, the user can add and delete candidates of the NTP server set as the time source. Therefore, the user can select a candidate of the NTP server set as the time source, and a measurement result having a high quality can be obtained.

In addition, the control unit 9 deletes an NTP server that satisfies a predetermined condition from the candidates of the NTP server set as the time source.

Accordingly, the NTP server satisfying the predetermined condition is deleted from the candidates of the NTP server set as the time source. Therefore, an NTP server or the like having low accuracy is automatically deleted, and a measurement result having a high quality can be obtained.

Further, the control unit 9 records information on the selected time source, together with the measurement result.

Accordingly, the information on the time source selected at that time is recorded, together with the measurement result. Therefore, the measurement result and the information on the time source can be associated with each other, and the quality of the measurement result can be determined from the information on the time source.

In the present embodiment, although the configuration in which the transmission and reception unit 5 is used in combination as the network connection unit is illustrated, a configuration in which a dedicated network connection unit is provided may be used. In addition, the network connection unit is configured to use the network for acquiring the time and the network for the network under test or the device under test, and to connect to the NTP server, but a configuration may be adopted in which a dedicated connection unit (transmission and reception unit for acquiring the time) for the network for acquiring the time is provided. Further, a time acquisition terminal (not illustrated) different from the measurement terminal 13 may be provided, and the time acquisition terminal may be connected to the transmission and reception unit 5 or a time acquisition transmission and reception unit (not illustrated) to be connected to a time acquisition network.

Hitherto, the embodiments of the present invention have been disclosed, but it is clear that changes can be made by those skilled in the art without departing from the scope of the present invention. All such modifications and equivalents are intended to be included in the following Claims.

### DESCRIPTION OF REFERENCE NUMERALS AND SIGNS

1: Network test apparatus

4: GNSS receiver

5: Transmission and reception unit (network connection unit)

6: Reference oscillator

7: 1PPS signal generation unit

8: Display operation unit

9: Control unit

71: Counter

91: Measurement unit

What is claimed is:

1. A network test apparatus comprising:
a reference oscillator that generates an oscillation signal having a predetermined frequency;
a control unit that controls the frequency of the oscillation signal generated by the reference oscillator; and
a network connection unit that is connected to a network and communicates with a device connected to the network,
wherein the control unit selects, via the network connection unit, an NTP server that is connected to the network and satisfies a predetermined NTP server condition, and sets the NTP server as a time source.

2. The network test apparatus according to claim 1, further comprising:
a GNSS receiver that receives a GNSS signal from a GNSS satellite,
wherein in a case where there is no NTP server satisfying the NTP server condition, the control unit selects a GNSS signal satisfying a predetermined GNSS signal condition from the GNSS signal received by the GNSS receiver, and sets the GNSS signal as the time source.

3. The network test apparatus according to claim 2,
wherein in a case where there is no NTP server satisfying the NTP server condition and there is no GNSS signal satisfying the GNSS signal condition, the control unit searches for an NTP server satisfying a delay time or a fluctuation, which is the NTP server condition, or a GNSS signal satisfying a signal strength or a signal quality, which is the GNSS signal condition, in accordance with a preset priority.

4. The network test apparatus according to claim 2,
wherein the control unit switches the time source according to a predetermined measurement condition, a predetermined cycle, or an operation by a user.

5. The network test apparatus according to claim 2,
wherein the control unit changes the NTP server condition or the GNSS signal condition in accordance with a measurement item or a measurement scene in network measurement.

6. The network test apparatus according to claim 2,
wherein the control unit sets the NTP server condition or the GNSS signal condition according to a selected time accuracy or measurement accuracy.

7. The network test apparatus according to claim 2,
wherein the control unit stores a plurality of candidates of the NTP server set as the time source, and enables a user to add and delete the candidate.

8. The network test apparatus according to claim 7,
wherein the control unit deletes an NTP server that satisfies a predetermined condition, from the candidates of the NTP server set as the time source.

9. The network test apparatus according to claim 2,
wherein the control unit records information on the selected time source, together with a measurement result.

10. A time source selection method of a network test apparatus including a reference oscillator that generates an oscillation signal having a predetermined frequency, a network connection unit that is connected to a network and communicates with a device connected to the network, and a control unit that controls the frequency of the oscillation signal generated by the reference oscillator, the method comprising:
a step of selecting, via the network connection unit, an NTP server that is connected to the network and satisfies a predetermined NTP server condition, and setting the NTP server as a time source.

11. The time source selection method according to claim 10,
wherein the network test apparatus further includes a GNSS receiver that receives a GNSS signal from a GNSS satellite, and
in a case where there is no NTP server satisfying the NTP server condition, the control unit selects a GNSS signal satisfying a predetermined GNSS signal condition from the GNSS signal received by the GNSS receiver, and sets the GNSS signal as the time source.

12. The time source selection method according to claim 11,
wherein in a case where there is no NTP server satisfying the NTP server condition and there is no GNSS signal satisfying the GNSS signal condition, the control unit searches for an NTP server satisfying the NTP server condition or a GNSS signal satisfying the GNSS signal condition, in accordance with a preset priority.

13. The time source selection method according to claim 11,
wherein the control unit switches the time source according to a predetermined measurement condition, a predetermined cycle, or an operation by a user.

14. The time source selection method according to claim 11,
wherein the control unit changes the NTP server condition or the GNSS signal condition in accordance with a measurement item or a measurement scene in network measurement.

15. The time source selection method according to claim 11,
wherein the control unit sets the NTP server condition or the GNSS signal condition according to a selected time accuracy or measurement accuracy.

16. The time source selection method according to claim 11,
wherein the control unit stores a plurality of candidates of the NTP server set as the time source, and enables a user to add and delete the candidate.

17. The time source selection method according to claim 16,
wherein the control unit deletes an NTP server that satisfies a predetermined condition, from the candidates of the NTP server set as the time source.

18. The time source selection method according to claim 11,
wherein the control unit records information on the selected time source, together with a measurement result.
